(19) United States
(12) Patent Application Publication
(10) Pub. No.: US 2014/0335483 A1
(43) Pub. Date: Nov. 13, 2014

(54) LANGUAGE PROFICIENCY DETECTION IN SOCIAL APPLICATIONS

(71) Applicant: GOOGLE INC., Mountain View, CA (US)

(72) Inventors: Kirill BURYAK, MOUNTAIN VIEW, CA (US); Luke Hiro SWARTZ, MOUNTAIN VIEW, CA (US); Andrew SWERDLOW, MOUNTAIN VIEW, CA (US); Cibu JOHNY, MOUNTAIN VIEW, CA (US)

(21) Appl. No.: 13/892,842

(22) Filed: May 13, 2013

(51) Int. Cl. G09B 5/08

(52) U.S. Cl. CPC G09B 5/08
USPC 434/167

(57) ABSTRACT

Social networking applications may be improved by incorporating a user's language proficiency to make content suggestions to the user. A language preference of a user, which may represent one of a plurality of signals, may be received. A signal may be, for example, an online activity of the user, a text generated or received by the user, or content requested by the user. At least one of the plurality of signals may be analyzed using a machine learning program. A machine learning program may be trained on data for a test group of users with a known language proficiency. A user-assigned language proficiency may be incorporated as a signal in training a machine learning program. The language proficiency of the user may be determined based upon the analysis of at least one of the plurality of signals. Content may be presented to the user based upon the language proficiency of the user.

### BACKGROUND

One area of significant growth in the internet in the last decade has been social networking Social networking applications may allow users to associate or connect with interest groups or to select friends or persons of interest from whom they would like to receive content or with whom they would like to associate. More generally, social networking applications may allow users to modify their social graphs. For example, users may elect to associate with a person of interest, an interest group, a friend, an image, or audio or video content. A social graph may describe a user's relationship to the rest of the world. A social graph may be provided, for example, via an application or a web browser. While some websites offering a social networking application may provide, for example, a friend suggestion, the suggestion is often based on a probability that the potential friend is known by the user. This type of friend suggestion ignores other potential ways of modifying the user's social graph.

### BRIEF SUMMARY

According to an implementation of the disclosed subject matter, one or more signals and a language preference of the user may be received. The language preference may indicate at least one language, such as a language in which a user prefers to receive information. Data for a test group of users may be obtained, for each of which language proficiencies and one or more signals may be known. A machine learning program may be trained on the data for the test group of users and the one or more signals for each user. The one or more signals and the language preference of the user may be analyzed using the trained machine learning program. The language proficiency of the user may be determined based upon the one or more signals, the language preference of the user, and the trained machine learning program. The language proficiency may be stored to a computer readable medium. Content may be presented to the user based upon the determined language proficiency of the user.

In an implementation, a language preference of a user may be received as well as one or more signals. At least one of the signals may be analyzed using a machine learning program. The language proficiency of the user may be determined based upon at least one of the signals, the language preference and the trained machine learning program. Content may be presented to the user based upon the determined language proficiency of the user. Further, the stored language proficiency of the user may be modified based upon the one or more signals. A machine learning program may be used to analyze at least one of the signals. An estimated numeric value of the language proficiency of the user may be determined.

In an implementation, a database may store a language preference of a user. A processor may be connected to the database. The processor may be configured to receive one or more signals and the language preference of the user and analyze at least one of the signals and the language preference using a machine learning program. It may determine the language proficiency of the user based upon the at least one of the one or more signals, the language preference, and a trained machine learning program. The processor may be configured to present content to the user based upon the determined language proficiency of the user. The system may further comprise modifying the stored language proficiency of the user based upon the one or more signals by performing an analysis of at least one of the one or more signals using a machine learning program. An estimated numeric value of the language proficiency of the user also may be determined.

Implementations disclosed herein may allow for automated determination of a user's language proficiency based upon activity of the user on a social networking application. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example of determining a user's language proficiency according to an implementation of the disclosed subject matter.

FIG. 4 shows an example arrangement and information flow for determining a user's language proficiency based upon one or more signals according to an implementation of the disclosed subject matter.

FIG. 5 shows an example of a computational system configured to respond to the language preference input and determine a user's language proficiency according to an implementation of the disclosed subject matter.

### DETAILED DESCRIPTION

Many users are multilingual and would benefit from having language considered in their social graph. For example, a user who speaks French, Chinese, and Hindi may desire to post content, such as a text message, in Chinese, and have that message be visible only to her Chinese-speaking friends. Alternatively, the user may desire to create friend groups based upon the languages she speaks, such as a Hindi-fluent friends group. Utilizing a variety of signals and a user's language preference to modify the user's social graph may provide for an enhanced user experience on social networking applications. According to implementations of the disclosed subject matter, a user of a social networking application may modify a social graph based upon the user's language proficiency. Once a user's language proficiency has been determined, who may see a posting based upon the language preference of the viewer may be determined by the user or automatically. A posting may refer to a content item that a user has selected or directed for presentation. A user may specify friend groups or persons of interests using the social networking application or any of the implementations as disclosed herein. More generally, the disclosed subject matter contemplates modifying a social graph of the user according to the user's language proficiency, where the language proficiency may be determined based upon, for example, an analysis of the user's language preference and social networking signals such as content viewed or requested by the user. The analysis may be performed by a machine learning approach that utilizes a test group of individuals for which information is available about various signals associated with each individual, such as their language preference or their self-determined language proficiency.

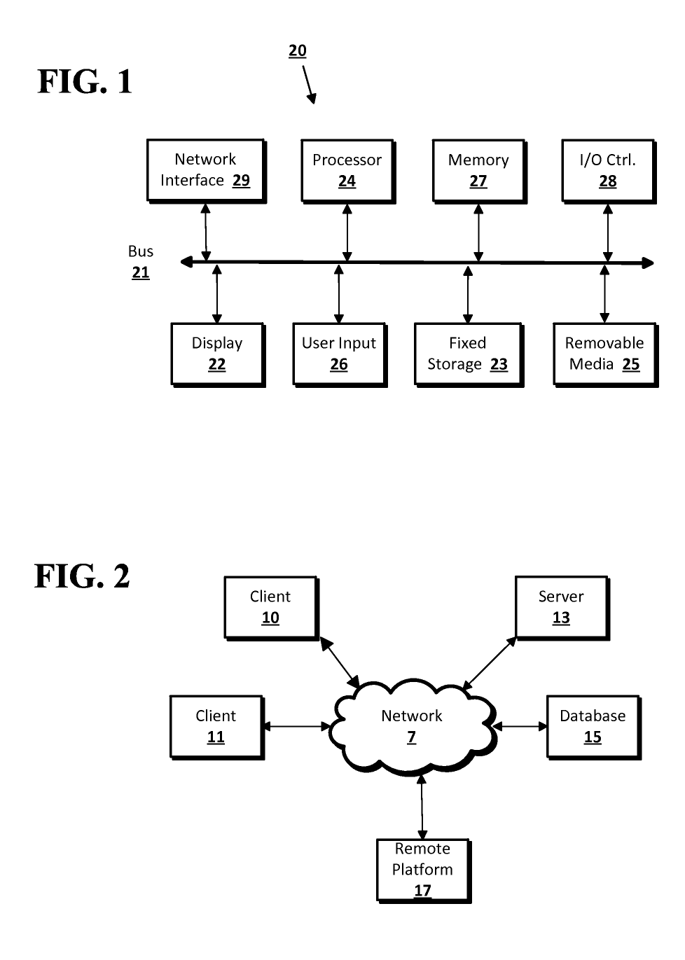

Implementations of the presently disclosed subject matter may be implemented in and used with a variety of component and network architectures. FIG. 1 is an example computer 20 suitable for performing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be performed using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

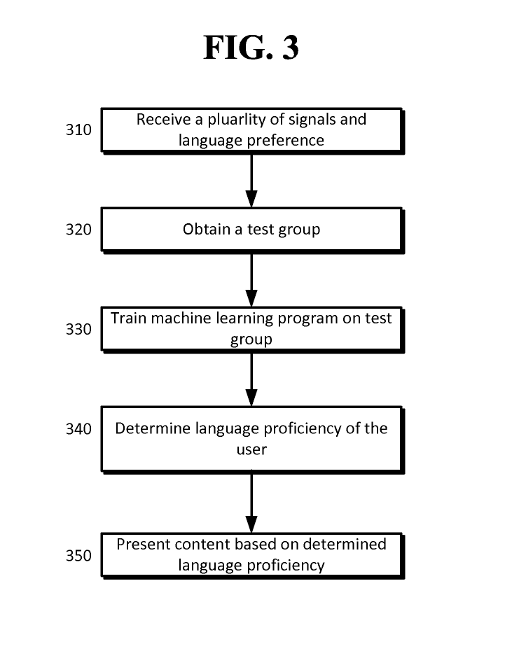

Shown in FIG. 3 is an implementation of the disclosed subject matter. One or more signals, including a language preference of the user, may be received at 310. Typically, a signal refers to data within the context of a social networking application. A signal may include, for example, an online activity of the user, a music selection of the user, a media selection of the user, a frequency of posts of the user in a social network application, a length of a post of the user in a social network application, an email, a frequency of email sent by the user, a frequency of email received by the user, a size of email sent by the user, a size of email received by the user, a comment of the user, a length of a text item accessed by the user, a length of a text item created by the user, an amount of time spent reading a text item, an amount of time creating a text item, an amount of time editing a text item, a text item provided by the user, speech of the user, a language proficiency of the user, or any combination thereof. A language proficiency of the user may be explicitly established by the user, such as by specifying a language proficiency for one or more languages. For example, a user may select a language proficiency of 50% for Hindi and 75% for Chinese using a sliding scale interface on an application or other appropriate user interface. As another example, a user may indicate a language proficiency by more generalized categories based on the user's self-assessed ability to read, write, or speak a given language. These different user-specified classifications may be interpreted as signals that may indicate the level of assistance the user requires with content in a certain language.

A user's language preference may indicate at least one language in which a user is able to, or prefers to receive content. A language preference may, for example, include a selection of a language by the user in which to display content. It also may be set as a particular language by default. A user may decide not to specify a language, in which case a language preference may be inferred from a variety of language indicators other than the user-specified language preference. Typically, language indicators are data received outside of the context of a social networking application. Language indicators may include, for example: (1) a URL parameter, such as a parameter that indicates a previously-selected language or similar setting, (2) a user application-specific override, (3) a general user language preferences, (4) a cookie or setting stored in cookie, (5) a browser accept-language, (6) a language override for another application, which may be arranged in descending usage order, (7) a user agent, (8) an enterprise administrator's language policy setting, and (9) an IP address. For example, a URL parameter may include a computer-readable code, such as “h1=” followed by a language tag, included in a URL to the desired language a user would like a webpage to display. As another example, a cookie can include computer-readable code that can transmit state information from a webpage to a user's browser and from a user's browser to the webpage. Similarly, an “accept-language” computer readable code typically specifies the languages a browser may use.

A language preference may be stored to a computer readable medium, and may be accessed from the computer readable medium by a social networking application. A user may have an online account associated with a social networking application. The language preference may be stored to a server and thereby associated with the account of the user. If the user elects not to input a language preference and the language preference is determined using another language indicator, the language preference may, for example, be stored to and accessed from a local area such as a hard disk drive.

Data for a test group of users may be obtained at 320. The data may include, for each user in the test group, one or more known signals. A machine learning program may be trained using the data for the test group of users and/or the one or more signals for each user at 330. The machine learning program may operate by determining characteristics associated with the one or more signals for each user in the group that provide insight into the language proficiency of members of the test group. For example, the signals may relate observed variables to a language proficiency that may be determined by a user or computationally. The machine learning program may be incorporated into an application as a component of language resolution, or applied independently to determine what content may be provided to a user. A machine learning program that has been trained on the data for the test group may be utilized to make intelligent decisions regarding content based on, for example, exhibited patterns of behavior and the language preference of a user or group of users. Further training, adjustment, or other improvement of a machine learning program may include testing alternative machine learning programs or varying the number or amount of signals input into a given machine learning program to improve the effectiveness or efficiency of the machine learning system. Training may refer to, for example, running a machine learning program using a test set of data to establish various parameters for the program, which are then applied to similar sets of data not used during the training process. The efficacy of a particular training set or a particular machine learning program may be determined by how well the machine learning program approximates the language proficiency of a member of the test group. The results of a machine learning program may be compared to other machine learning programs and replicate experiments that contain a modified signal input. A machine learning program may also be used to cluster users into groups that are associated traits.

The language proficiency of the user may be determined based upon one or more signals, the language preference of the user, and the trained machine learning program at 340. The language proficiency of the user may be stored to a computer readable medium, and accessed by a social networking application. A user may have an online account associated with a social networking application. The language proficiency may be stored to a server and thereby associated with the account of the user. Alternatively, or in addition, the language proficiency may be stored to and accessed from a local area such as a hard disk drive. Users may be clustered based upon the language proficiency of each of the users. This may, for example, permit better targeting of content to users who match a determined set of features associated with the clustered users.

Content may be presented to the user based upon the language proficiency of the user at 350. Content may refer to, for example, images, audio, video, graphics, text, a user group, an interest group, a person of interest, or a friend group. In some contexts content may refer to anything sent or otherwise provided to an end user. In a social networking context, friend associations, interest groups, persons of interest associations, or other components of a social graph may be considered social networking content. A social graph may describe the associations the user has with the rest of the world and it may overlap with forms of social networking content, for example, a friend group, person of interest, or interest group.

A language associated with content may be determined or obtained based on, for example, tags associated with the content, an analysis of text associated with the content, an analysis of audio associated with the content, and/or an analysis of supplemental content associated with the content. Supplemental content may include, for example, comments associated with a video, a geographic location of the source, an IP address, information known about the source providing the content, etc. For example, a Canadian individual may vacation in China and record a Chinese play. An analysis of the audio from the video may indicate that the language is Chinese. The geographic location of the source may be identified as Canadian and the language associated with the source may be English. The Canadian may have posted the video on a social stream where comments were received that were also in English. Thus, the content may be associated with the Chinese and English languages. In some configurations, it may be desirable to rank the associated languages with content. For example, the language associated with the source may be prioritized or ranked above an audio analysis of the content.

Presenting content is not limited to presenting content in a language in which a user is proficient. In some configurations, it may refer to suggesting a friend or friend group on a social networking application. For example, if a user's native language is Russian and the user is determined to have a fluency in the French language, the user may be recommended a French celebrity to follow via a social networking application. For example, a social networking application may generate friend recommendations based on information known about a user. In some instances, a use may indicate an interest in a particular person, show, or content and a recommendation may be made based thereon. In some configurations, a user may be presented options on how much content to translate. For example, if a user's native language is Russian and the user has a moderate fluency for the French language, the user may be presented an article in French, but the user may be able to hover over text to receive a translation. If the user has a poor fluency in the French language, the user may always receive a machine translated version of content. Thus, the step of presenting content 350 may include translation of content to a language in which the user has the highest fluency or displaying some or all of the content in its original language and/or providing the user with an option as to how much of the content is to be translated.

Presenting content may include, for example, filtering a social graph of the user or content based upon the language proficiency of the user, publishing to a social networking application, grouping individuals associated with the user, translating content according to the language proficiency of the user, targeting the user with an advertisement, or the like. An advertisement, for example, may be expressed and/or relevant to individuals who speak a language in which content is presented. For example, a user interested in a first French television show may be recommended a celebrity associated therewith by a social networking application based on the user's French language proficiency. A video advertisement that is in the French language for a second French television show may be deemed to target users interested in the first television show. The advertisement may only be presented, however, to French speaking individuals. Similarly, publishing may include, for example, posting content on a user's web page on a social networking application or similar location. As described earlier, content may have one or more languages associated with it, typically including an indication of one or more languages in which the content is available. Content may be presented using an audio, video, or tactile method of displaying or delivering content. The presented content may be stored to a computer readable medium and accessed for further analysis to modify the user's assessed language proficiency.

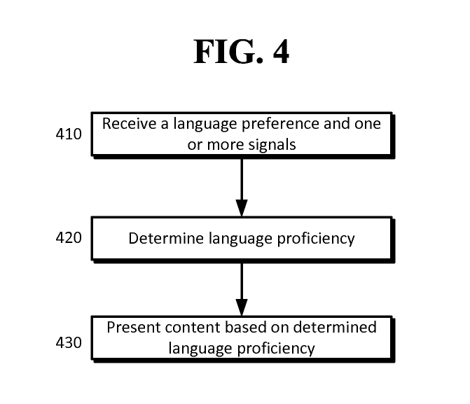

In an implementation of the disclosed subject matter shown in FIG. 4, a language preference of a user and one or more signals may be received at 410. A language preference may be received through, for example, a language preference selection control that may be provided as a component of a social networking or other application. The language preference selection control may allow a user to establish a list of languages in which the user would prefer to have content presented. It also may allow a user to specify a hierarchy for language presentation. For example, if the user desires content in French, Chinese, and Hindi, these languages may be indicated in the language preference selection control. The order of the languages may also be recorded or utilized for language resolution of content or as a signal for a machine learning program. Continuing the example, if content is not available for the French language, but is available for Chinese or Hindi languages, a language resolution program may default to the Chinese language for the content because it is the next most-preferred language in which the user desires content to be presented.

As described earlier, a variety of signals may be employed to ascertain a feature set that may have some predictive ability with respect to the language proficiency of a user. In addition, a variety of machine learning programs may be tested or used in combination to identify those programs and features that enable more predictive results. The language proficiency of the user may be determined based upon the at least one of the signals, the language preference, and a trained machine learning program at 420. Content may be presented to the user based upon the language proficiency of the user at 430. Presenting content may include, as stated earlier, audio or visual methods, as well as a translation. For example, suppose a user has been designated by a machine learning program as having poor language proficiency for Russian, but the user desires content that is only provided in Russian. According to an implementation of the disclosed subject matter, the determined language proficiency indicates that the user will likely require a translation of the content to a language consistent with the user's language preference. A prompt to the user for such a translation may be made. Over time, the user may become more adept at the Russian language. A machine learning program may be adaptive, responding to such a change by examining the one or more signals at an interval to modify the user's determined language proficiency. The subsequent modification of the user's language proficiency may require a new analysis of the one or more signals by the machine learning program and such an analysis may exclude a test group of users. For example, a user may be presented with a prompt to input or enter a language proficiency. A prompt may include, for example, a web browser and/or application that allows a user to input a language proficiency.

In some instances, a user may provide an indication of a language proficiency. The language proficiency of the user may be updated and/or revised utilizing the user's specified language proficiency. For example, the user's language proficiency may be used to override a language proficiency based on the trained machine learning program. In some configurations, the user's specified language proficiency may be used as a component of a machine learning program. For example, the user's specified language proficiency may be weighted and/or have a certain value compared to other signals used in the machine learning program. In some instances, the trained machine learning program may be revised based on an indication of language proficiency that has been received. A new language proficiency (e.g., revised language proficiency) may be determined or computed based on the revised machine learning program. As stated earlier, the received indication may cause the weight assigned to a particular language or proficiency level for a particular language to vary and thereby change the resulting the way content may be presented to the user. New or different signals, different assigned weights to signals used in a previous language proficiency determination, or different machine learning programs may be used. Thus, the proficiency level associated with a language for a user may be revised and/or updated based on an analysis provided by the machine learning algorithm and/or an indication received from the user.

A machine learning algorithm may be trained on a test group of users, each of whom may have a known language proficiency. A language proficiency may be known, for example, where the user specifies a level of proficiency, or where a user's activity is observed and a score is assigned by a qualified professional. One or more signals may be provided to the algorithm and these signals may be used to predict the language proficiency on the test group of users. Subsequent iterations of the algorithm may weigh, add, and/or remove one or more of the signals, and again predict the language proficiency of the test group of users. Once the algorithm has closely or satisfactorily approximated the language proficiency of the test group of users, the machine learning algorithm may be deemed trained, and it may be applied to an experimental sample or other group of users, or signals obtained therefrom.

In addition, the user may provide an indication of a language proficiency for herself and this self-assigned language proficiency determination may be used as a signal in a computationally determined language proficiency for the user. For example, a user may indicate a language proficiency for an application using a sliding scale interface. The user may indicate a language proficiency for Hindi as 50% and for Chinese as 75%. A user may indicate a language proficiency by more generalized categories such as the ability to read, write, or speak a given language. A language proficiency may be inferred based upon the user's demonstrated ability to read, write or speak a given language. An estimated numerical value of the language proficiency of the user may be determined, and may be represented as a percentile of proficiency compared to a population of users or a comprehension indicated by the user. For example, a user may rate herself in the 90^{th} percentile of users with respect to her fluency for the French language. Alternatively, the user may indicate that she understands approximately 90% of French text. In some instances, a user may configure whether the computationally determined proficiency overrides a user indicated proficiency or not.

For example, a user may have one or more preferred languages defined in a profile (e.g., language preference). Each language may correspond with a proficiency level. For example, a user may have a proficiency level in English numerically indicated as 1.0, Russian numerically indicated as 0.6, and Polish numerically indicated as 0.1. This may indicate that the user is fluent in English, has a working knowledge of Russian, and a rudimentary fluency of Polish. As disclosed herein, the proficiency level may be input by the user or computationally determined using (e.g., using a machine learning method), for example, by analyzing a user's content (e.g., the language content in sent/received emails, social posts, news articles, etc.). A confidence level may be assigned for each signal such as a self-declared language, browser language settings (e.g., accept-language), browser build language, IP address of the user, etc. For example, a user's declared language may be assigned a value of 1.0 while a browser build language may be assigned a value of 0.5. A weighted value for a language may be obtained by multiplying the proficiency level by the confidence level of the language signal. The language weights may be utilized to rank and/or prioritize the social stream content for a specific user to match the user's language preferences. In some configurations, the rank of each piece of content (e.g., determined based on others factors, such as user interest, a friend connection, etc.) may be multiplied by the language weight corresponding to the language of the specific piece of content. The content presented to a user may then be ranked again according to the content that best matches the user's language preferences.

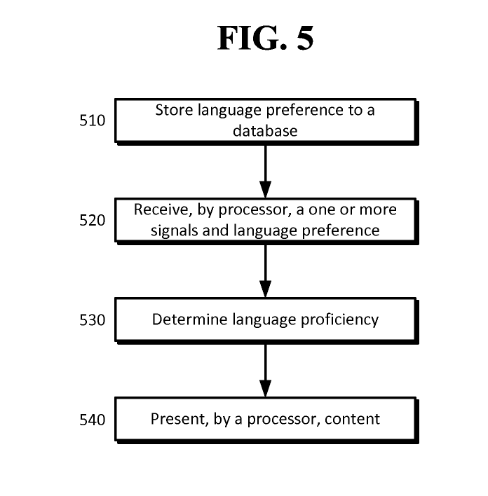

FIG. 5 displays another implementation of the disclosed subject matter. A database may store a language preference of a user at 510. A processor may be connected to the database that receives one or more signals and the language preference of the user at 520. The processor may be configured to determine the language proficiency of the user based upon at least one of the signals, the language preference of the user, and a trained machine learning program at 530, for example as disclosed above with respect to FIGS. 3 and 4. The processor may be configured to present content to the user based upon the language proficiency of the user at 540. The content, language proficiency of the user, and the language preference of the user may be stored to a computer readable medium that may also be accessed by a social networking or other application.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a plurality of signals including a language preference of a user, the language preference indicating at least one language;
obtaining data for a test group of users for each of which a plurality of signals is known;
training a machine learning program using the data for the test group of users and the plurality of signals for each user;
determining a language proficiency of the user based upon plurality of signals, the language preference of the user, and the trained machine learning program;
storing the language proficiency to a computer readable medium; and
presenting content to the user based upon the language proficiency of the user.

2. A method comprising:
receiving a language preference of a user and a plurality of signals;
determining a language proficiency of the user based upon the at least one of the signals, the language preference, and a trained machine learning program; and
presenting content to the user based upon the language proficiency of the user.

3. The method of claim 2, wherein one of the plurality of signals is selected from the group consisting of: an online activity of the user, a music selection of the user, a media selection of the user, a frequency of posts of the user in a social network application, a length of a post of the user in a social network application, an email, a frequency of email sent by the user, a frequency of email received by the user, a size of email sent by the user, a size of email received by the user, a comment of the user, a length of a text item accessed by the user, a length of a text item created by the user, an amount of time spent reading a text item, an amount of time creating a text item, an amount of time editing a text item, a text item provided by the user, speech of the user, and a language proficiency of the user.

4. The method of claim 2, further comprising:
receiving an indication of language proficiency from the user; and
updating the language proficiency of the user based on the indication.

5. The method of claim 2, further comprising:
receiving an indication of the language proficiency;
revising the trained machine learning program according to the indication; and
determining, by the revised trained machine learning program, a revised language proficiency.

6. The method of claim 2, further comprising receiving, from the user, an indication of a viewer that is allowed to see a posting based upon a language preference of the viewer.

7. The method of claim 2, further comprising receiving an indication of the language proficiency from the user.

8. The method of claim 2, wherein the step of presenting the content comprises providing a translation of content according to the language proficiency of the user.

9. The method of claim 2, wherein the step of presenting the content comprises filtering content according to the language proficiency of the user.

10. The method of claim 2, further comprising clustering a plurality of users based upon the language proficiency of each of the plurality of users.

11. The method of claim 2, wherein the step of presenting the content to the user comprises targeting the user with an advertisement.

12. The method of claim 2, further comprising modifying the language proficiency of the user by performing an analysis of at least one of the plurality of signals using a machine learning program.

13. The method of claim 12, further comprising determining an estimated numeric value of the language proficiency of the user.

14. The method of claim 12, wherein each of the one or more signals is selected from the group consisting of: an online activity of the user, a music selection of the user, a media selection of the user, a frequency of posts of the user in a social network application, a length of a post of the user in a social network application, an email, a frequency of email sent by the user, a frequency of email received by the user, a size of email sent by the user, a size of email received by the user, a comment of the user, a length of a text item accessed by the user, a length of a text item created by the user, an amount of time spent reading a text item, an amount of time creating a text item, an amount of time editing a text item, a text item provided by the user, speech of the user, and a language proficiency of the user.

15. A system comprising:
a database storing a language preference of a user;
a processor connected to the database, the processor configured to:
receive a plurality of signals and the language preference of the user;
determine a language proficiency of the user based upon the at least one of the plurality of signals, the language preference, and a trained machine learning program; and
present content to the user based upon the language proficiency of the user.

16. The system of claim 15, wherein one of the plurality of signals is selected from the group consisting of: an online activity of the user, a music selection of the user, a media selection of the user, a frequency of posts of the user in a social network application, a length of a post of the user in a social network application, an email, a frequency of email sent by the user, a frequency of email received by the user, a size of email sent by the user, a size of email received by the user, a comment of the user, a length of a text item accessed by the user, a length of a text item created by the user, an amount of time spent reading a text item, an amount of time creating a text item, an amount of time editing a text item, a text item provided by the user, speech of the user, and a language proficiency of the user.

17. The system of claim 15, the processor further configured to:
receive an indication of language proficiency from the user; and
update the language proficiency of the user based on the indication.

18. The system of claim 15, the processor further configured to:
receive an indication of the language proficiency;
revise the trained machine learning program according to the indication; and
determine, by the revised trained machine learning program, a revised language proficiency.

19. The system of claim 15, the processor further configured to receive, from the user, an indication of a viewer that is allowed to see a posting based upon a language preference of the viewer.

20. The system of claim 15, the processor further configured to receive an indication of the language proficiency from the user.

21. The system of claim 15, wherein the step of presenting the content comprises providing a translation of content according to the language proficiency of the user.

22. The system of claim 15, wherein the step of presenting the content comprises filtering content according to the language proficiency of the user.

23. The system of claim 15, further comprising clustering a plurality of users based upon the language proficiency of each of the plurality of users.

24. The system of claim 15, wherein the step of presenting the content to the user comprises targeting the user with an advertisement.

25. The system of claim 15, further comprising modifying the language proficiency of the user by performing an analysis of at least one of the plurality of signals using a machine learning program.

26. The system of claim 25, further comprising determining an estimated numeric value of the language proficiency of the user.

27. The system of claim 25, wherein each of the one or more signals is selected from the group consisting of: an online activity of the user, a music selection of the user, a media selection of the user, a frequency of posts of the user in a social network application, a length of a post of the user in a social network application, an email, a frequency of email sent by the user, a frequency of email received by the user, a size of email sent by the user, a size of email received by the user, a comment of the user, a length of a text item accessed by the user, a length of a text item created by the user, an amount of time spent reading a text item, an amount of time creating a text item, an amount of time editing a text item, a text item provided by the user, speech of the user, and a language proficiency of the user.
